(19) United States
(12) Patent Application Publication
(10) Pub. No.: US 2013/0325724 A1
(43) Pub. Date: Dec. 5, 2013

(54) REMITTANCE SUBSCRIPTION

(71) Applicants: Adolfo Babatz, San Mateo, CA (US); Hisham Ibrahim, Scotts Valley, CA (US); Dana Worth, San Francisco, CA (US); Jose Fernandez-da Ponte, Saratoga, CA (US)

(72) Inventors: Adolfo Babatz, San Mateo, CA (US); Hisham Ibrahim, Scotts Valley, CA (US); Dana Worth, San Francisco, CA (US); Jose Fernandez-da Ponte, Saratoga, CA (US)

(21) Appl. No.: 13/909,897

(22) Filed: Jun. 4, 2013

Related U.S. Application Data
(60) Provisional application No. 61/655,346, filed on Jun. 4, 2012.

(51) Int. Cl. G06Q 20/10

(52) U.S. Cl. CPC G06Q 20/10
USPC 705/44

(57) ABSTRACT

A payment provider offers a subscription service for remittances. Users of the payment provider service may elect to pay a set monthly fee (or other periodic fee), which allows a user to send unlimited remittances during the period without any additional fees for each remittance transaction. In other words, a user may elect to pay a flat fee to forego per transaction remittance fees. The fee may be the same for all users or may differ based on various factors, which can include the number of remittances the user expects to send during the period, the total amount of money expected to be sent, the residences of intended recipients, etc.

### CROSS REFERENCE TO RELATED APPLICATION

The present application claims priority to U.S. Provisional Patent Application Ser. No. 61/655,346, filed Jun. 4, 2012, which is incorporated by reference in its entirety.

### BACKGROUND

1. Field of the Invention

The present invention generally relates to electronic remittances.

2. Related Art

People send money or remittances to others for various reasons, such as helping relatives or loved ones with rent, living expenses, food, utilities, clothing, repairs, medical bills, insurance, education, etc. Money is also sent for “non-essential” items, such as for the recipient to buy something for themselves, such as a gift, a nice meal, a movie, etc.

Typical ways to send money include mailing a personal check, cashier's check, or cash, making a wire transfer, and using the services of payment providers, such as banks or PayPal, Inc. of San Jose, Calif.

Due in part to fees associated with remittances, most people may only send money periodically and in larger amounts to reduce the number of per transaction fees. However, this may not be ideal for the recipient and/or the sender. For example, the recipient may need money immediately, but has either not saved enough from a previous remittance or cannot wait for the next remittance. In another example, the sender may not be able to monitor how the recipient spends or manages the money due to the larger, less frequent remittances.

People may also be more hesitant to send remittances to others in different countries, such as for fear of the money not arriving safely in the hands of the intended recipient, higher fees associated with “cross-border” transactions, etc.

Therefore, a need exists to enable users to send remittances without the disadvantages of conventional methods and models.

### BRIEF DESCRIPTION OF THE FIGURES

FIG. 1 is a flowchart showing a process for sending a remittance according to one embodiment;

FIG. 2 is block diagram of a networked system suitable for implementing the process described herein according to an embodiment; and

FIG. 3 is a block diagram of a computer system suitable for implementing one or more components in FIG. 2 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a payment provider offers a subscription service for remittances. Users of the payment provider service may elect to pay a set monthly fee (or other periodic fee), which allows a user to send unlimited remittances during the period without any additional fees for each remittance transaction. In other words, a user may elect to pay a flat fee to forego per transaction remittance fees. The fee may be the same for all users or may differ based on various factors, which can include the number of remittances the user expects to send during the period, the total amount of money expected to be sent, the residences of intended recipients, etc. Incidental fees may be added in different embodiments, such as for currency conversion.

As a result, a user can send money as needed or desired without worrying about transaction fees. This provides several other advantages as well, such as ease of sending and receiving money (sending through a PC, computing tablet, or mobile device and receiving immediately at an ATM, bank, or store) and security for both the sender and recipient (sender requires authentication and recipient can pick up money at secure locations or deposit electronically directly into an account). Other advantages include the ability for a sender to send funds when they have the money and not have to wait for a next remittance period, resulting in the sender not spending funds before that period starts. This can also result in recipients receiving funds more frequently, resulting in convenience for the recipient in not having to save or allocate a larger remittance and a higher likelihood the funds received are used for their intended purpose. Yet another advance is that it both the sender and receiver can carry smaller amounts of cash due to the ability to send and receive more frequent, but smaller amounts, of cash.

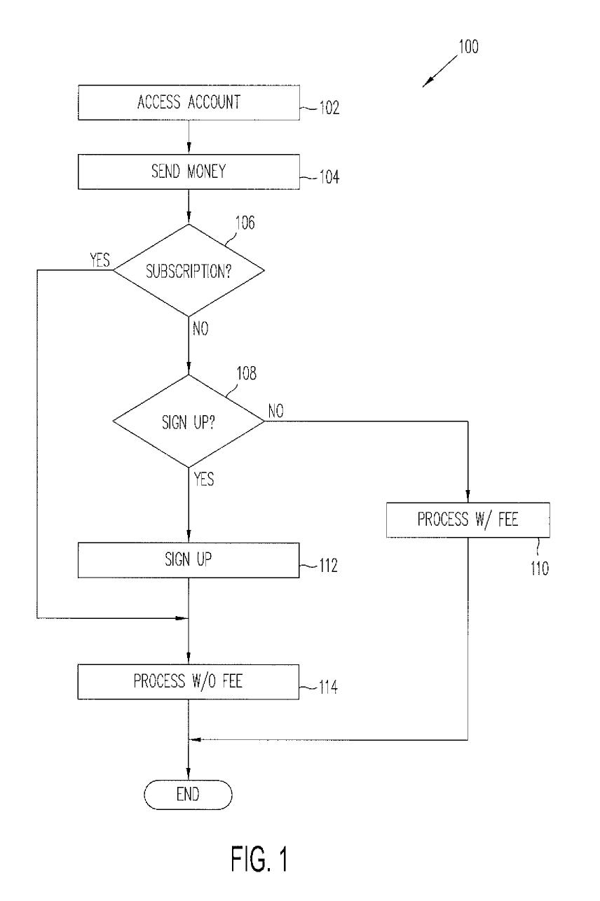

FIG. 1 is a flowchart showing a process 100 for sending a remittance according to one embodiment. At step 102, a user who desires to send money or a remittance accesses the user's account with a payment provider, such as PayPal, Inc. of San Jose, Calif. The user may access the account through a user device, such as a PC, smart phone, computing tablet, or other computing device. Typically, the user enters information, such as a user identifier (email address, user name, phone number, etc.) and a password or PIN associated with the user account. The user identifier may be prefilled or known by the payment provider, such as through a device ID. In that case, the user simply needs to enter the password or PIN.

Once authenticated by the payment provider, the user may select, at step 104, an option to send money or a remittance from the user's account. For example, the user may select a link, button, or tab in an account page. The user may be asked to provide recipient information, amount of the remittance, and any other information, such as date the money is to be sent. The requested information can be provided through a keypad or keyboard associated with the user device, through selection from a drop down menu, through a contact list, by voice, and/or other means. The recipient information may be a phone number, a user name, an email address, an account number, a mailing address, or other recipient identifier. Note that the recipient need not have an account with the payment provider. The date may be immediately, the same day, or a specific day selected from the user such as from a calendar.

Next, at step 106, a determination is made whether the user has a subscription for remittances. For example, the payment provider may check the user's account to determine whether the user has paid or signed up for a subscription service or offering or whether the user has an active subscription. A subscription, in one embodiment, is a flat fee paid by the user, which allows the user to send as many remittances as the user desires within the paid period. The paid period may be a month, three months, six months, a year, or other time period. In one embodiment, the payment provider may offer different types of subscriptions, such as based on the number of remittances allowed per time period, a minimum or maximum amount that can be sent with each remittance, and a total dollar amount that can sent during the subscription period. Other limitations to a user's subscription may also be present, such as authorized or unauthorized recipients, user-imposed or payment provider-imposed (such as based on user-account maximums or limits) maximum remittance dollar amounts, authorized and unauthorized recipient locations, etc.

If the user has a valid subscription and the remittance is within any limitations of the subscription, the payment provider processes the remittance, at step 114, without charging a fee to the user for the transaction. Processing may include debiting the user's payment provider account and crediting an account of the recipient. If the user does not have sufficient funds in one or more funding accounts, the user may be asked to fund an account, such as by adding money through an ATM, online, or check, or to add a funding source, such as a credit card, debit card, bank account, or the like.

The account for crediting may be an account with the payment provider or with another entity, such as a bank. In the filmier case, the recipient may transfer the funds to a recipient bank account and then retrieve the funds or cash from a local bank or ATM. In the latter case, the user may retrieve the funds or cash from the bank or ATM,

The recipient may also receive funds in other ways. For example, the payment provider may provide the recipient a transaction receipt, which can be presented at appropriate locations for the recipient to receive the funds. Locations may include banks, retailer/merchant stores, ATMs, kiosks, and other cash-dispensing locations or machines. The receipt may be a physical receipt sent to the recipient. The receipt may also be a digital receipt sent to the recipient's mobile device or email address. The receipt may be in the form of a scannable barcode (such as a QR code), a sequence of numbers and/or letters, etc., where the receipt is associated with the remittance. The receipt may also have an expiration date or time.

When the recipient presents the receipt to receive the funds, the payment provider may verify the accuracy of the receipt before releasing funds to the recipient or instructing a merchant/teller or other person to give the funds to the recipient. The payment provider and/or the cash-dispensing entity or person may also verify the recipient is the actual intended recipient, such as asking for an identification to match up with the receipt. The sender or user may receive a notification that the recipient has retrieved the funds.

Returning back to step 106, if the user does not have a valid subscription, the user may be asked, at step 108, whether the user wishes to sign up for the remittance service. Details of the service may be provided, such as the cost, time period, services, and advantages provided. There may be different levels or offerings of remittance services, as discussed above. Details may be provided after the user answers one or more questions. For example, the user may be asked where the remittances will be sent (e.g., which countries), frequency (e.g., every week, four times a month, etc.), dollar amount (e.g., average per remittance, total for a period, etc.), type of delivery to recipient (as discussed above), period of subscription, etc. Based on the answers, the payment provider may provide a price to the user. The price may also be dependent on information about the user, as contrasted with information provided by the user. Information about the user may include how long the user has had an account with the payment provider, history of purchases and transactions, timeliness of payments, credit history, history of remittances, etc. Thus, in one embodiment, the same remittance service may be offered at different costs to different users. Remittance services may also be personalized for the user, as determined by the service provider based on the user information. Thus, the service provider may provide standard remittance service packages in addition to one or more personalized remittance service packages for the user to choose from.

If the user desires to sign up for a remittance service, a sign-up process is completed at step 112. This may include the user selecting the desired remittance offering and confirming the purchase. The payment provider may then deduct the subscription price from the user's account with the payment provider. The user may receive a confirmation, with or without details, of the subscription purchase.

In one embodiment, the user may set limits or conditions on the remittances. For example, the user may set a maximum dollar amount for each remittance, a maximum number of remittances for a set period, which need not be the period of the paid subscription period, identify a list of approved and/or unauthorized recipients, etc. In one embodiment, the limits or conditions may be revised during the remittance period, either by the user or by the service provider, such as when conditions change for the user.

If the user has a current subscription, but conditions of the subscription do not allow the money transfer to be made without incurring fees or the subscription has expired, the user may be asked to take an appropriate action to enable the current remittance to be processed under a subscription. For example, a per transaction dollar amount may be exceeded, the number of remittances for the period may have been reached, or other restriction/condition not met. In this case, the user may be given the option of changing one or more parameters of the subscription account, such as increasing the dollar amount or increasing the number of remittances for a period. Corresponding charges may be incurred if the change corresponds to a higher priced subscription service.

Once sign-up is completed, the payment provider may process the remittance, at step 114, without charging the user a specific transaction fee for the remittance.

Referring back to step 108, if the user does not have a currently valid subscription and does not wish to sign up or pay for a subscription, the payment provider processes the remittance with a standard transaction fee at step 110. The processing may include debiting the remittance amount and a transaction fee from the user's payment provider account and providing the funds to the recipient, as discussed above.

Thus, by providing the user with an option to pre-pay or pay a flat fee for remittances, the user need not worry about how many remittances are sent and how little the amount may be. This can result in the user being more engaged and connected with recipient(s), such as family members and loved ones in different parts of the country or world. Timely remittances can also be sent for specific needs or wants, resulting in a higher likelihood that the recipient will use the cash for its intended purpose, as opposed to the recipient trying to save a larger, less frequent remittance for future needs. User-specific remittance options may be provided for a more customized product for the user.

Note that one or more of the above steps may be combined, omitted, or performed in a different sequence as desired.

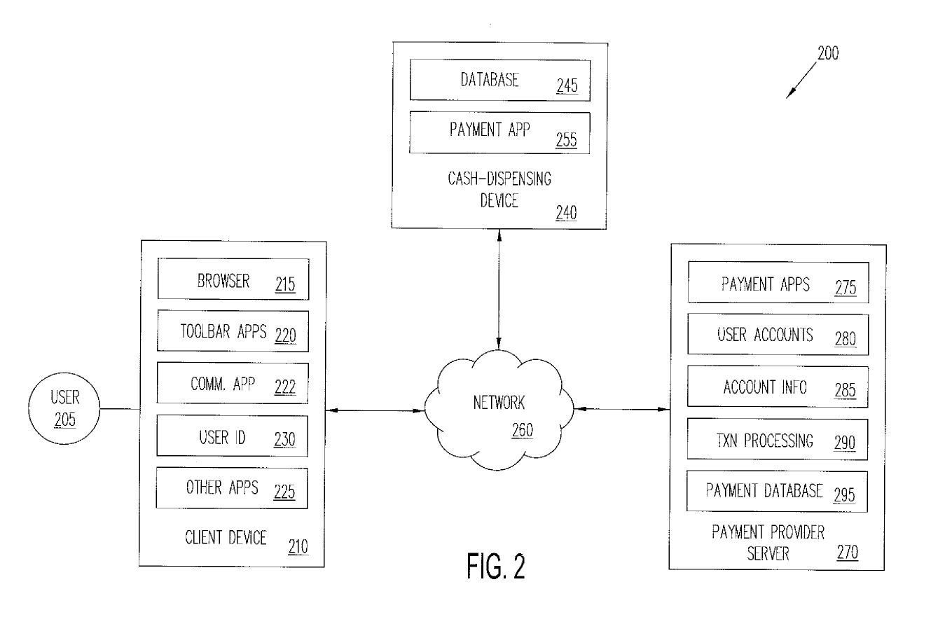

FIG. 2 is a block diagram of a networked system 200 configured to handle a transaction, such as described above, in accordance with an embodiment of the invention. System 200 includes a user device 210, a cash-dispenser server 240, and a payment provider server 270 in communication over a network 260. Payment provider server 270 may be maintained by a payment provider, such as PayPal, Inc. of San Jose, Calif. A user 205, such as a sender, utilizes user device 210 to perform a transaction using payment provider server 270. Note that transaction, as used herein, refers to any suitable action performed using the user device, including payments, transfer of information, display of information, etc.

User device 210, cash-dispenser server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), computing tablet, and/or other types of computing devices capable of transmitting and/or receiving data.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such accessing a site of the payment provider. User device 210 may also include one or more toolbar applications 220 which may be used, for example, to provide client-side processing for performing desired tasks in response to operations selected by user 205. In one embodiment, toolbar application 220 may display a user interface in connection with browser application 215 as described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, transfer information, make payments or send remittances through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

Cash-dispenser server 240 may be maintained, for example, by cash dispensing entity, such as a retailer, bank, kiosk, ATM, for dispensing funds to a recipient from a remittance processed over network 260. Cash-dispenser server 240 includes a database 245 identifying deposits or other funds available for a recipient sent by user 205 through the payment provider. Cash-dispenser server 240 also includes a payment application 255 which may be configured to facilitate the disbursement of funds for a recipient. Payment application 255 may be configured to determine whether a recipient is to be given funds, such as based on a receipt presented by the recipient.

Payment provider server 270 may be maintained, for example, by an online payment service provider which may provide payment services for user 205, such as facilitating a remittance from the user to a recipient. In this regard, payment provider server 270 includes one or more payment applications 275 which may be configured to interact with user device 210 and/or cash-dispending server 240 over network 260 to facilitate the transfer of money by user 205 to a recipient as discussed above.

Payment provider server 270 also maintains a plurality of user accounts 280, each of which may include account information 285 associated with individual users, including subscription plans and status of such plans. For example, account information 285 may include private financial information of users of devices such as account numbers, passwords, device identifiers, user names, phone numbers, credit card information, bank information, or other financial information which may be used to facilitate online transactions by user 205. Account information may also include user payment history, which may include details of remittances sent. Advantageously, payment application 275 may be configured to interact with cash-dispensing server 240 on behalf of user 205 as part of a remittance process.

A transaction processing application 290, which may be part of payment application 275 or separate, may be configured to receive information from a user device and/or cash-dispensing server 240 for processing and storage in a payment database 295. Transaction processing application 290 may include one or more applications to process information from user 205 for processing a remittance as described herein. As such, transaction processing application 290 may store details of a remittance associated with individual users. Payment application 275 may be further configured to determine the existence of and to manage accounts for user 205, as well as create new accounts if necessary, such as the set up, management, and use of subscription plans as discussed herein.

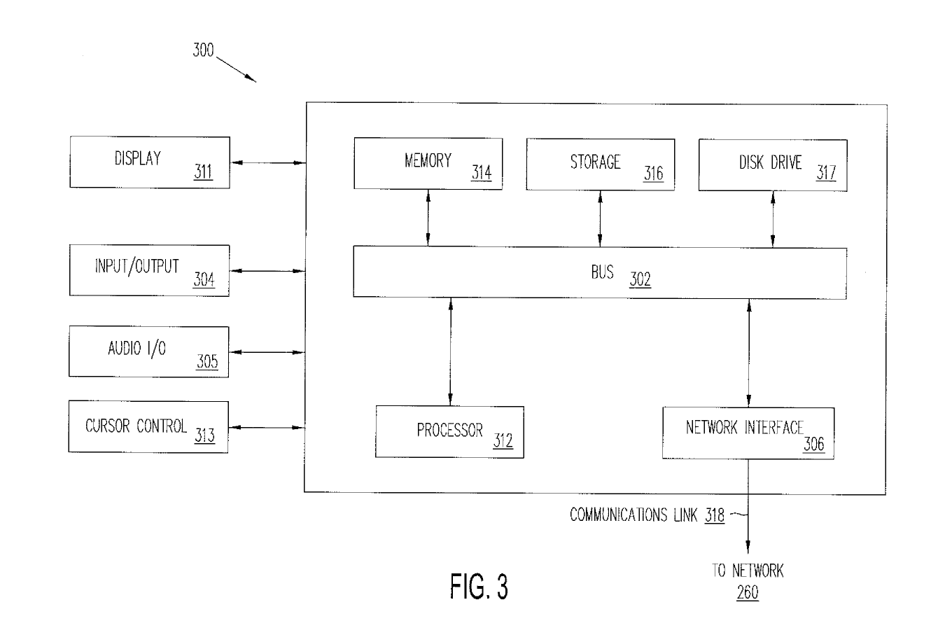

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

We claim:

1. A system comprising:
a memory storing account information for a plurality of users, wherein the account information comprises information about subscription plans for individual users;
one or more processors operable to:
receive, from a user, a request to send money to a recipient;
determine whether the user has a subscription plan;
determine whether the request can be approved based on the subscription plan and any other account information; and
process, by a payment provider, a money transfer on behalf of the user to the recipient without charging the user an individual transaction fee for the money transfer.

2. The system of claim 1, wherein the subscription plan provides the user unlimited money transfers within a time period of the subscription plan in exchange for a one-time fee paid by the user to the payment provider.

3. The system of claim 1, wherein the subscription plan provides the user a predetermined number money transfers within a time period of the subscription plan in exchange for a one-time fee paid by the user to the payment provider.

4. The system of claim 1, wherein the subscription comprises conditions defined by the user.

5. The system of claim 4, wherein the conditions comprise a maximum number of money transfers, a maximum dollar amount for a single money transfer, a maximum dollar amount of all transfers within a time period, one or more names of approved recipients, or one or more names of unauthorized recipients.

6. The system of claim 1, wherein the recipient is in a different country than the user.

7. The system of claim 1, wherein the recipient does not have to have an account with the payment provider.

8. The system of claim 1, wherein the recipient retrieves the money from a bank, cash-dispensing machine, or a retailer.

9. The system of claim 1, wherein the subscription plan and/or a cost of the subscription plan is dependent on information about the user.

10. A method for performing a transaction using a user device, comprising:
receiving, from the user device, a request to send money to a recipient;
determining, by one or more processors of a payment provider, whether the user has a subscription plan;
determining, by one or more processors of the payment provider, whether the request can be approved based on the subscription plan and any other account information; and
processing, by one or more processors of the payment provider, a money transfer on behalf of the user to the recipient without charging the user an individual transaction fee for the money transfer.

11. The method of claim 10, wherein the subscription plan provides the user unlimited money transfers within a time period of the subscription plan in exchange for a one-time fee paid by the user to the payment provider.

12. The method of claim 10, wherein the subscription plan provides the user a predetermined number money transfers within a time period of the subscription plan in exchange for a one-time fee paid by the user to the payment provider.

13. The method of claim 10, wherein the subscription comprises conditions defined by the user.

14. The method of claim 13, wherein the conditions comprise a maximum number of money transfers, a maximum dollar amount for a single money transfer, a maximum dollar amount of all transfers within a time period, one or more names of approved recipients, or one or more names of unauthorized recipients.

15. The method of claim 10, wherein the subscription plan and/or a cost of the subscription plan is dependent on information about the user.

16. A non-transitory machine-readable medium comprising a plurality of machine-readable instructions which when executed by one or more processors of a server are adapted to cause the server to perform a method comprising:
receiving, from a user, a request to send money to a recipient;
determining whether the user has a subscription plan;
determining whether the request can be approved based on the subscription plan and any other account information; and
processing, by a payment provider, a money transfer on behalf of the user to the recipient without charging the user an individual transaction fee for the money transfer.

17. The non-transitory machine-readable medium of claim 16, wherein the subscription plan provides the user unlimited money transfers within a time period of the subscription plan in exchange for a one-time fee paid by the user to the payment provider.

18. The non-transitory machine-readable medium of claim 16, wherein the subscription plan provides the user a predetermined number money transfers within a time period of the subscription plan in exchange for a one-time fee paid by the user to the payment provider.

19. The non-transitory machine-readable medium of claim 16, wherein the subscription comprises conditions defined by the user.

20. The non-transitory machine-readable medium of claim 16, wherein the subscription plan and/or a cost of the subscription plan is dependent on information about the user.
